(19) United States
(12) Patent Application Publication
(10) Pub. No.: US 2017/0046952 A1
(43) Pub. Date: Feb. 16, 2017

(54) Dangerous Vehicle Warning Method and Dangerous Vehicle Warning System

(71) Applicants: Inventec (Pudong) Technology Corp., Shanghai (CN); Inventec Corporation, Taipei (TW)

(72) Inventors: Tsung-Cheng Yang, Taipei (TW); Chao-Hui Shen, Taipei (TW); Chen-Yu Wang, Taipei (TW)

(21) Appl. No.: 14/881,179

(22) Filed: Oct. 13, 2015

(30) Foreign Application Priority Data
Aug. 12, 2015 (CN) 201510492450.1

(51) Int. Cl. G08G 1/017; G06K 9/62; G06F 17/30; G06K 9/00

(52) U.S. Cl. CPC G08G 1/0175; G06K 9/00791; G06K 9/6202; G06F 17/30253; G06F 17/30864; G06K 2209/15

(57) ABSTRACT

A dangerous vehicle warning method is disclosed. The dangerous vehicle warning method is utilized in a dangerous vehicle warning system including a vehicle electronic system and a cloud server. The dangerous vehicle warning system, disposed in a first vehicle, includes an image capturing module and a license number identifying module. The dangerous vehicle warning method includes the image capturing module capturing an image of an area surrounding the first vehicle; the license number identifying module identifying a license number information of a second vehicle in the area surrounding the first vehicle according to the image; comparing the license number information with a dangerous vehicle list stored in the cloud server and generating a comparing result; and generating a warning signal according to the comparing result.

### BACKGROUND OF THE INVENTION

1. Field of the Invention

The present invention relates to a dangerous vehicle warning method and a dangerous vehicle warning system, and more particularly, to a dangerous vehicle warning method and a dangerous vehicle warning system capable of providing warning signal according to driving record.

2. Description of the Prior Art

As traffic safety is more important, vehicle safety equipment is getting more varied. In addition to active or passive safety systems (such as anti-lock braking systems, electronic brake-force distribution systems, traction control systems, electronic stability systems, supplementary restraint systems, etc.), pre-warning protection systems attract more attention. The pre-warning protection system uses an image self-recognition method of machine vision to detect possible situation which may cause danger (e.g., collision between vehicles), and sends out a warning light signal or an alarm sound to a driver in advance. The driver may change a driving direction or a driving speed according to the alarm signals, to avoid a traffic accident due to the driver' s carelessness or being in a visually blind spot.

In addition, a traffic accident is highly related to driving records of other vehicles. Some vehicles are constantly overtaking or tailgating others. Some owners of vehicles may have many drunk-driving records. Vehicles with bad driving record may have a higher chance to be harmful to other vehicles, and cause traffic accidents and traffic disputes. If drivers can keep the vehicles with bad driving record away in advance, the traffic accident and traffic dispute may be avoided and the drivers would not get into necessary troubles. However, the pre-warning protection system in the art only detects possible collision of vehicles, without reflecting driving record of other vehicles. Therefore, how to provide a warning signal according to driving record is a significant objective in the field.

### SUMMARY OF THE INVENTION

It is therefore a primary objective of the present invention to provide a dangerous vehicle warning method and a dangerous vehicle warning system capable of providing a warning signal according to driving record, to improve road traffic safety.

The present invention discloses a dangerous vehicle warning method utilized in a dangerous vehicle warning system. The dangerous vehicle warning system comprises a vehicle electronic system and a cloud server. The dangerous vehicle warning system is disposed on a first vehicle. The dangerous vehicle warning system comprises an image capturing module and a license number identifying module. The dangerous vehicle warning method comprising the image capturing module capturing an image of an area surrounding the first vehicle; the license number identifying module identifying a license number information of a second vehicle in the area surrounding the first vehicle according to the image; comparing the license number information with a dangerous vehicle list stored in the cloud server and generating a comparing result; and generating a warning signal according to the comparing result.

The present invention further discloses a dangerous vehicle warning system. The dangerous vehicle warning system comprises a cloud server, comprising a dangerous vehicle list; and a vehicle electronic system, disposed on a first vehicle, the vehicle electronic system comprises an image capturing module, configured to capture an image of an area surrounding the first vehicle; a license number identifying module, configured to identify a license number information of a second vehicle in the area surrounding the first vehicle according to the image; and a warning module, configured to generate a warning signal according to a comparing result; wherein the comparing result is generated by comparing the license number information with the dangerous vehicle list.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a dangerous vehicle warning system according to an embodiment of the present invention.

FIG. 2 is a schematic diagram of a dangerous vehicle warning process according to an embodiment of the present invention.

FIG. 3 is a schematic diagram of a dangerous vehicle warning process according to an embodiment of the present invention.

FIG. 4 is a schematic diagram of a dangerous vehicle warning system according to an embodiment of the present invention.

### DETAILED DESCRIPTION

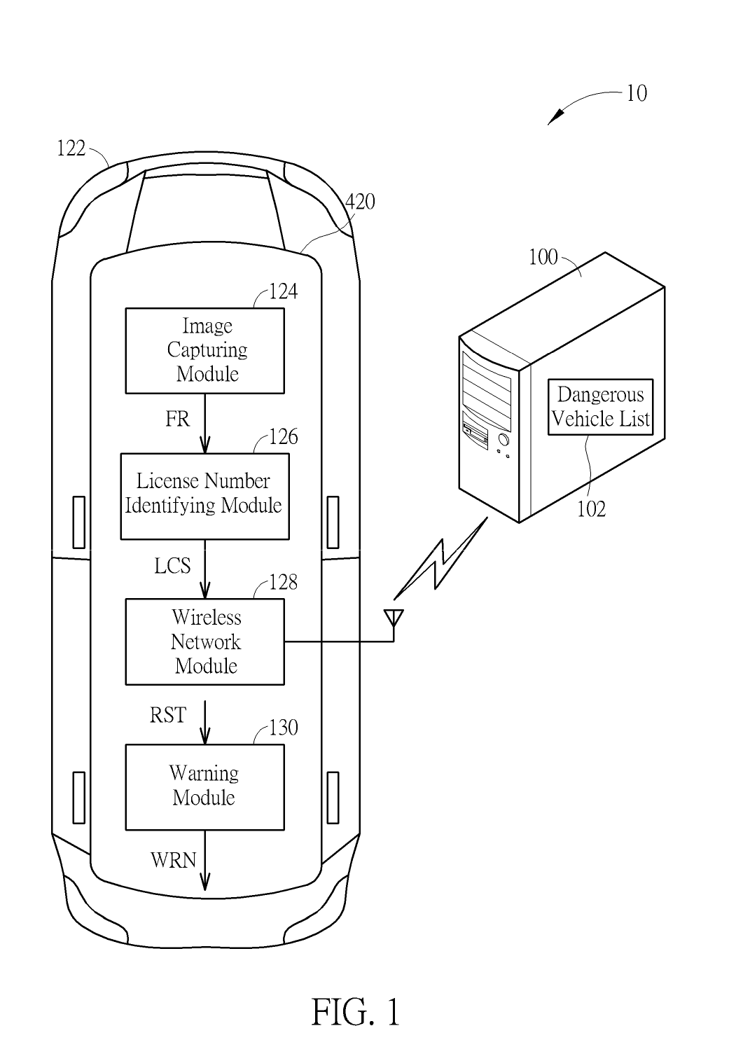

FIG. 1 is a schematic diagram of a dangerous vehicle warning system 10 according to an embodiment of the present invention. The dangerous vehicle warning system 10 comprises a cloud server 100 and a vehicle electronic system 120. The cloud server 100 maybe disposed in a government agency or a civil institution. In the cloud server 100, a dangerous vehicle list 102 is stored. The dangerous vehicle list 102 is a global dangerous vehicle list of an area of a governmental motor vehicles office. The dangerous vehicle list 102 contains a plurality of license numbers of dangerous vehicles. The dangerous vehicles maybe determined according to accident records or violation records provided by the motor vehicles office, or determined as being exposed by civilian people. In other words, the dangerous vehicles are vehicles with bad driving records, and the dangerous vehicle list 102 contains license numbers of all dangerous vehicles within the area governed by the motor vehicles office. The vehicle electronic system 120 is disposed on a first vehicle 122. The vehicle electronic system 120 comprises an image capturing module 124, a license number identifying module 126, a wireless network module 128 and a warning module 130. The image capturing module 124 may be a camera device such as a dashboard camera, a rearview camera, etc. The image capturing module 124 is configured to capture an image FR of an area surrounding the first vehicle 122. The license number identifying module 126 is coupled to the image capturing module 124 to receive the image FR captured by the image capturing module 124. The license number identifying module 126 is configured to identify a license number information LCS of a vehicle in the area surrounding the first vehicle 122 according to the image FR. After the license number identifying module 126 identifies the license number information LCS, the vehicle electronic system 120 utilizes the wireless network module 128 to establish a wireless connection with the cloud server 100, such that the license number information LCS is able to be compared with the dangerous vehicle list 102 stored in the cloud server 100, and a comparing result RST is generated. The warning module 130 generates a warning signal WRN according to the comparing result RST, to warn the driver that there is dangerous vehicle nearby.

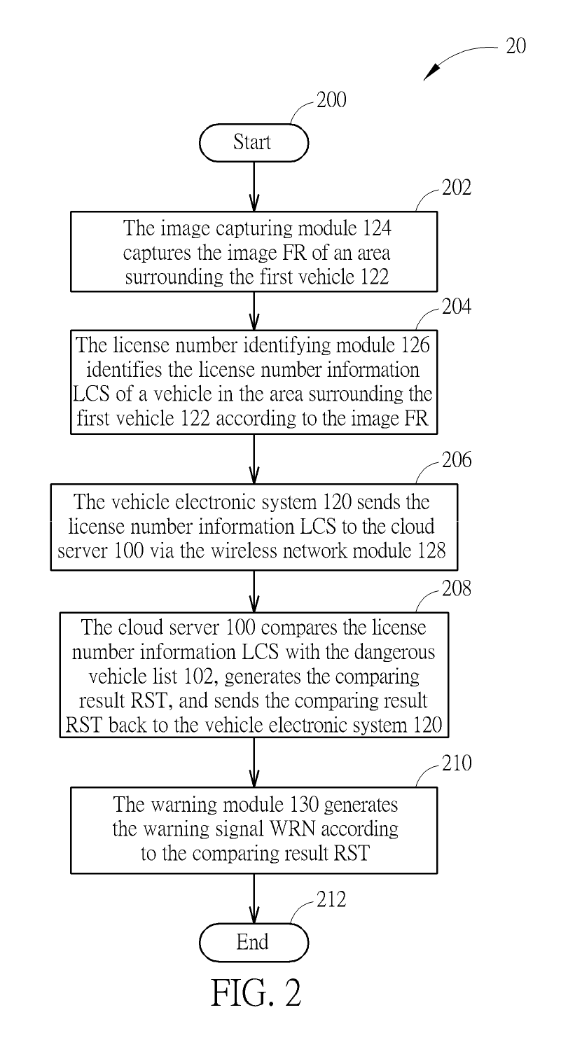

In detail, FIG. 2 is a schematic diagram of a dangerous vehicle warning process 20 according to an embodiment of the present invention. The dangerous vehicle warning process 20, executed by the dangerous vehicle warning system 10, comprises the following steps:

Step 200: Start.

Step 202: The image capturing module 124 captures the image FR of an area surrounding the first vehicle 122.

Step 204: The license number identifying module 126 identifies the license number information LCS of a vehicle in the area surrounding the first vehicle 122 according to the image FR.

Step 206: The vehicle electronic system 120 sends the license number information LCS to the cloud server 100 via the wireless network module 128.

Step 208: The cloud server 100 compares the license number information LCS with the dangerous vehicle list 102, generates the comparing result RST, and sends the comparing result RST back to the vehicle electronic system 120.

Step 210: The warning module 130 generates the warning signal WRN according to the comparing result RST.

Step 212: End.

According to the dangerous vehicle warning process 20, the vehicle electronic system 120 utilizes the image capturing module 124 and the license number identifying module 126 to obtain the license number information LCS, and utilizes the wireless network module 128 to connect to the cloud server 100. The cloud server 100 compares the license number information LCS with the dangerous vehicle list 102, and sends the comparing result RST back to the vehicle electronic system 120, such that the warning module 130 generates the warning signal WRN accordingly. Since the dangerous vehicle list 102 contains information of vehicles with bad records, the warning signal WRN is able to reflect driving record of surrounding vehicles. The driver may take appropriate measure (e.g., be alert, detouring, pulling over or slowing down to let the danger pass first) in advance, and avoid a traffic accident or traffic dispute.

In detail, in Step 202, the image capturing module 124 may be disposed on a top edge of a windshield, a front or rear bumper, a car door, a boot lid, etc. of the first vehicle 122, so as to capture the image FR in a front, a rear, or a side view of the first vehicle 122, where the image FR is an image of vehicles and license numbers thereof in front of, to the rear of, or to a side of the first vehicle 122. In Step 204, the license number identifying module 126 performs image processes such as frame partition, gray level processing, brightness adjustment, edge detection, text partition, text identification, and identify the license number information LCS of vehicle surrounding the first vehicle 122.

In Step 206, the vehicle electronic system 120 sends the license number information LCS to the cloud server 100 via the wireless network module 128. In an embodiment, the wireless network module 128 is a wireless local area network module under a standard of IEEE 802.11p. The wireless network module 128 may send the license number information LCS to base stations under the IEEE 802.11p standard disposed on a road side, the license number information LCS is sent to the cloud server 100 via the base stations.

In Step 208, after the cloud server 100 receives the license number information LCS, the cloud server 100 compares the license number information LCS with the dangerous vehicle list 102. When the license number information LCS is matched to a license number in the dangerous vehicle list 102, the cloud server 100 generates the comparing result RST as “matched”, and sends the comparing result RST back to the vehicle electronic system 120 via the base station and the wireless network module 128. In Step 210, after the vehicle electronic system 120 receives the comparing result RST, if the comparing result RST is “matched”, the warning module 130 generates the warning signal WRN to warn the driver.

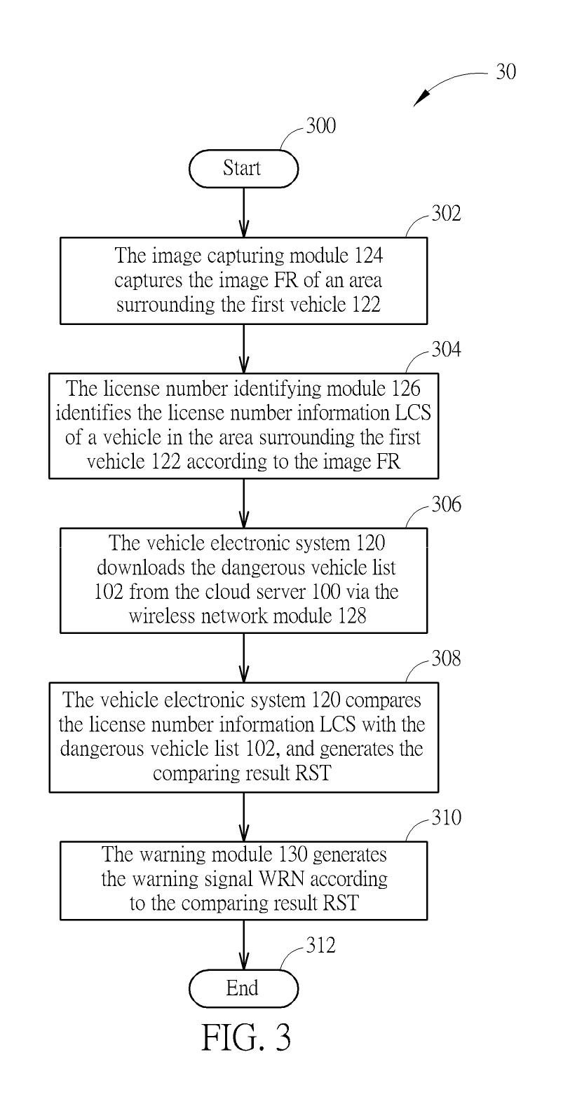

Notably, in the dangerous vehicle warning process 20, after the license number information LCS is identified, the license number information LCS is sent to the cloud server 100, and the cloud server 100 performs the comparison and generates the comparing result RST, which is not limited thereto. The dangerous vehicle list 102 may be downloaded by the vehicle electronic system 120 from the cloud server 100 and stored in a storage device of the vehicle electronic system 120 (not illustrated in FIG. 1). After the license number identifying module 126 identifies the license number information LCS, the vehicle electronic system 120 compares the license number information LCS with the dangerous vehicle list 102, and generates the comparing result RST. For example, please refer to FIG. 3, which is a schematic diagram of a dangerous vehicle warning system 30 according to an embodiment of the present invention. The dangerous vehicle warning process 30, executed by the dangerous vehicle warning system 10, comprises the following steps:

Step 300: Start.

Step 302: The image capturing module 124 captures the image FR of an area surrounding the first vehicle 122.

Step 304: The license number identifying module 126 identifies the license number information LCS of a vehicle in the area surrounding the first vehicle 122 according to the image FR.

Step 306: The vehicle electronic system 120 downloads the dangerous vehicle list 102 from the cloud server 100 via the wireless network module 128.

Step 308: The vehicle electronic system 120 compares the license number information LCS with the dangerous vehicle list 102, and generates the comparing result RST.

Step 310: The warning module 130 generates the warning signal WRN according to the comparing result RST.

Step 312: End.

The dangerous vehicle warning process 30 is similar to the dangerous vehicle warning process 20. Details of the dangerous vehicle warning process 30 maybe referred to paragraphs stated in the above, which is not narrated herein. Different from the dangerous vehicle warning process 20, the vehicle electronic system 120 downloads the dangerous vehicle list 102 via the wireless network module 128 (Step 306), and the vehicle electronic system 120 performs comparison between the license number information LCS and the dangerous vehicle list 102, and generates the comparing result RST (Step 308). Notably, an order performing Step 306 and Steps 302, 304 may be exchanged according to practically situation. In other words, the vehicle electronic system 120 may execute Step 306 first to download the dangerous vehicle list 102, and then execute Steps 302, 304 (to capture the image FR and identify the license number information LCS) and the following Steps 308-310, which is also within the scope of the present invention.

Notably, the embodiments stated in the above are utilized for illustrating concepts of the present invention. Those skilled in the art may make modifications and alternations accordingly, and not limited herein. For example, the wireless network module 128 is not limited to be wireless local area network module under the IEEE 802.11p. The wireless network module 128 may also be wireless network module under wireless cellular networks, which is also within the scope of the present invention. In addition, realizing the warning module 130 is not limited. In an embodiment, the warning module 130 may comprise an intelligence voice pronouncing module, and pronounce the warning signal WRN in voice. For example, the warning module 130 may pronounce voice warning as “Please be aware that the car approaching has many tailgating records.” In another embodiment, the warning module 130 may comprise a head up display (HUD), which is able to optically project information related to the dangerous vehicle (e.g., a direction and a license number of the dangerous vehicle) onto the windshield, such that the driver may perceive the information.

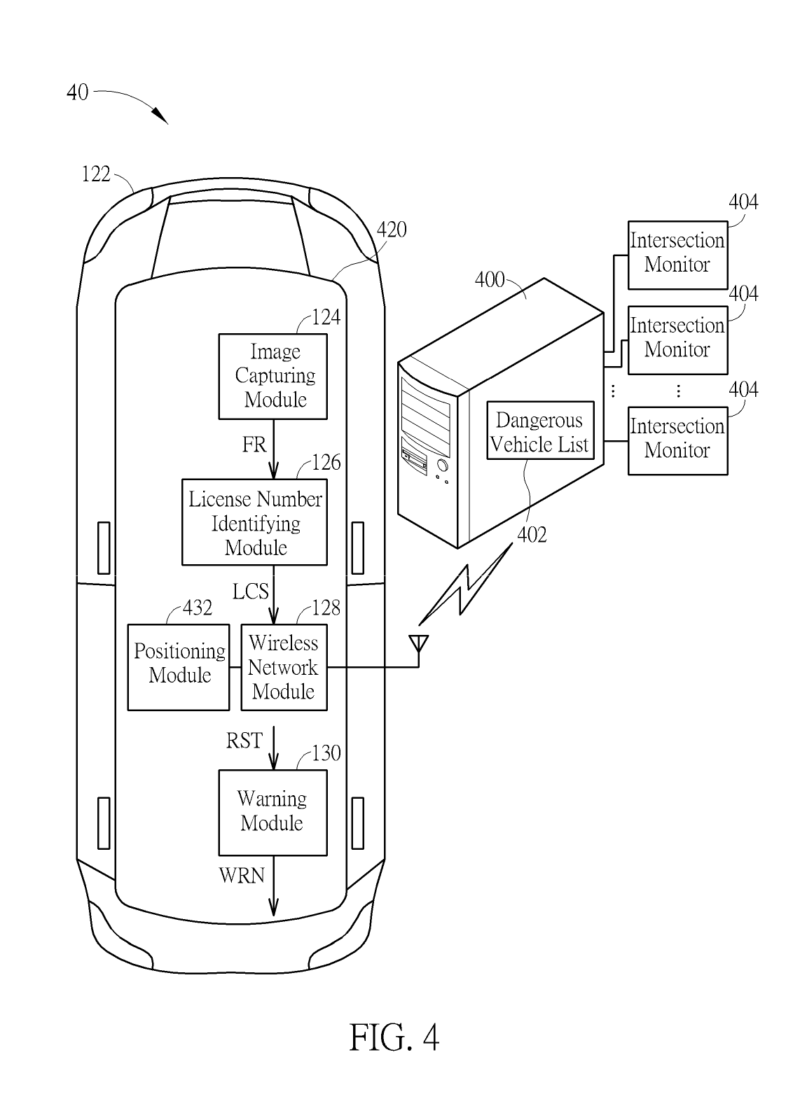

Furthermore, the cloud server may further generate a local dangerous vehicle list corresponding to the first vehicle according to a location of the first vehicle, to shorten a time comparing the license information and the dangerous vehicle list. For example, FIG. 4 is a schematic diagram of a dangerous vehicle warning system 40 according to an embodiment of the present invention. The dangerous vehicle warning system 40 is similar to the dangerous vehicle warning system 10, and thus, the same symbols are denoted by the same notations. Different from the dangerous vehicle warning system 10, a cloud server 400 may be coupled to a plurality of monitors 404 disposed on the road intersections, where the intersection monitors 404 are configured to obtain location information of dangerous vehicles. In other words, the cloud server 400 may obtain location information of dangerous vehicles by the intersection monitor 404. In addition, a vehicle electronic device 420 further comprises a positioning module 432, the positioning module 432 may be a navigating electronic device equipped with global positioning system (GPS). The positioning module 432 is configured to generate a location information or a dynamic information of the first vehicle 122. The dynamic information of the first vehicle 122 may include a speed information and a direction information of the first vehicle 122. The vehicle electronic device 420 may send the location information or the dynamic information of the first vehicle 122 to the cloud server 400 via the wireless network module 128. In such a situation, the cloud server 400 may generate a dangerous vehicle list 402 corresponding to the first vehicle 122 according to the location information of the dangerous vehicles and the location information or the dynamic information of the first vehicle 122. Compared with the dangerous vehicle list 102, the dangerous vehicle list 402 is a local dangerous vehicle list, which only contains dangerous vehicles within a neighborhood of the first vehicle 122 (i.e., the dangerous vehicles with distances in related to the vehicle 122 which are shorter than a specific distance). In general, the dangerous vehicle list 402 usually contains much fewer vehicles than the dangerous vehicle list 102. Hence, either the cloud server 400 or the vehicle electronic device 420 performs the comparison, a time for comparing the license number information and the dangerous vehicle list is shortened. Operational details of comparing the license number information and the dangerous vehicle list is the same as the dangerous vehicle warning process 20 and the dangerous vehicle warning process 30, which is not narrated herein.

In summary, the dangerous vehicle warning system of the present invention utilizes the image capturing module and the license number identifying module to obtain the license number information of surrounding vehicles, compares the license number information with the dangerous vehicle list via the wireless network module, and generate the warning signal according to the comparing result. Since the dangerous vehicle list contains information of vehicles with bad records, the warning signal is able to reflect driving record of surrounding vehicles. The driver may take appropriate measure (e.g., be alert, detouring, pulling over or slowing down to let the danger pass first) in advance, and avoid a traffic accident or traffic dispute.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dangerous vehicle warning method, utilized in a dangerous vehicle warning system, the dangerous vehicle warning system comprising a vehicle electronic system and a cloud server, the dangerous vehicle warning system disposed on a first vehicle, the dangerous vehicle warning system comprising an image capturing module and a license number identifying module, the dangerous vehicle warning method comprising:
the image capturing module capturing an image of an area surrounding the first vehicle;
the license number identifying module identifying a license number information of a second vehicle in the area surrounding the first vehicle according to the image;
comparing the license number information with a dangerous vehicle list stored in the cloud server and generating a comparing result; and
generating a warning signal according to the comparing result.

2. The dangerous vehicle warning of claim 1, wherein the step of comparing the license number information with the dangerous vehicle list stored in the cloud server and generating the comparing result comprises:
the vehicle electronic system sending the license number information to the cloud server via a wireless network module;
the cloud server comparing the license number information with the dangerous vehicle list; and
the cloud server generating the comparing result.

3. The dangerous vehicle warning of claim 1, wherein the step of comparing the license number information with the dangerous vehicle list stored in the cloud server and generating the comparing result comprises:
the vehicle electronic system receiving the dangerous vehicle list from the cloud server via a wireless network module;
the vehicle electronic system comparing the license number information with the dangerous vehicle list; and
the vehicle electronic system generating the comparing result.

4. The dangerous vehicle warning of claim 1, further comprising the vehicle electronic system sending a location information or a dynamic information of the first vehicle to the cloud server, and the cloud server generating the dangerous vehicle list according to the location information or the dynamic information.

5. A dangerous vehicle warning system, comprising:
a cloud server, comprising a dangerous vehicle list; and
a vehicle electronic system, disposed on a first vehicle, the vehicle electronic system comprising:
an image capturing module, configured to capture an image surrounding the first vehicle;
a license number identifying module, configured to identify a license number information of a second vehicle surrounding the first vehicle according to the image; and
a warning module, configured to generate a warning signal according to a comparing result;
wherein the comparing result is generated by comparing the license number information with the dangerous vehicle list.

6. The dangerous vehicle warning system of claim 5, wherein the vehicle electronic system comprises a wireless network module, configured to send the license number information to the cloud server or receive the dangerous vehicle list from the cloud server.

7. The dangerous vehicle warning system of claim 6, wherein when the vehicle electronic system sends the license number information to the cloud server, the cloud server compares the license number information with the dangerous vehicle list and generates the comparing result.

8. The dangerous vehicle warning system of claim 6, wherein when the vehicle electronic system receives the dangerous vehicle list from the cloud server, the vehicle electronic system compares the license number information with the dangerous vehicle list and generates the comparing result.

9. The dangerous vehicle warning system of claim 5, wherein the vehicle electronic system further comprises a positioning module, configured to generate a location information or a dynamic information of the first vehicle.

10. The dangerous vehicle warning system of claim 9, wherein the vehicle electronic system sends the location information or the dynamic information to the cloud server, and the cloud server generates the dangerous vehicle list according to the location information or the dynamic information.
